(19) United States
(12) Patent Application Publication
(10) Pub. No.: US 2015/0321685 A1
(43) Pub. Date: Nov. 12, 2015

(54) TWO WHEEL TILT STEERING WHEELBARROW

(71) Applicant: Max M. Smoot, Longmont, CO (US)

(72) Inventor: Max M. Smoot, Longmont, CO (US)

(21) Appl. No.: 14/555,978

(22) Filed: Nov. 28, 2014

Related U.S. Application Data
(60) Provisional application No. 61/988,901, filed on May 6, 2014.

(51) Int. Cl. B62B 1/24

(52) U.S. Cl. CPC B62B 1/24

(57) ABSTRACT

A two wheel tilt steering wheelbarrow has two handles attached to a tray, two skid legs, and two wheels. A front steering apparatus is adapted so that raising and lowering one handle relative to the other causes the wheels to turn left and right. Transfer of this tilting motion to wheel steering is accomplished through the use of a vertical yoke mounted on the handles and attached to a steering rocker bar via a steering hinge adapted so that the yoke can rotate, relative to the steering rocker bar, about the steering hinge. Two tie-rod plates attach the yoke to two tie-rod support members, which are themselves attached to two tie-rods. The tie-rods are also linked to the wheel axles via axle attachments such that rotating the yolk about the steering hinge pushes and pulls on the tie-rods and causes the wheels to turn.

### CROSS-REFERENCE TO RELATED APPLICATIONS

This application claims the benefit of U.S. Provisional Application No. 61/988,901 entitled TWO WHEEL TILT STEERING WHEELBARROW and filed on May 6, 2014), which is specifically incorporated by reference herein for all that it discloses and teaches.

### TECHNICAL FIELD

The present invention relates generally to the field of wheelbarrows; more particularly, to wheelbarrows having two front wheels; and more particularly still, to an improved two wheel tilt steering wheelbarrow.

### BACKGROUND

Wheelbarrows have been in common use for hundreds, if not thousands, of years. However, most have a single front wheel upon which the user must balance the load; such wheelbarrows are inherently unstable. A single stone in the wheel's path can cause the wheelbarrow to tilt rapidly to one side or the other, thereby unbalancing the load and causing the wheelbarrow to tip sideways, dumping the load in the wrong location.

In order to improve the stability of a wheelbarrow, especially when working with heavy loads, a second wheel can be placed in parallel with the first wheel. Such an arrangement greatly improves the stability of the wheelbarrow. However, this stability comes at a price: the resulting wheelbarrow can be difficult to turn, especially in tight spaces as the fixed wheels common on two-wheeled wheelbarrows do not tilt or turn. Another common issue with many wheelbarrows is that all the weight of the load presses downwards on the tray, causing the tray to deform around the handles since the handles provide the only support for the tray and its load.

What is needed is a wheelbarrow having two front wheels for stability that is reinforced so the tray doesn't deform around the handles, and that can turn easily without any complex steering wheel or other cumbersome mechanism.

### SUMMARY

One embodiment of the present invention can comprise a pair of handles attached to a tray, a pair of skid legs, and a pair of wheels. Connecting the wheels to the handles is a front steering apparatus adapted so that raising the first handle relative to the second handle causes the first and second wheels to turn left and lowering the first handle relative to the second handle causes the first and second wheels to turn right.

This relatively simple transfer of tilting motion to steering is accomplished through the use of a rear vertical yoke mounted on the handles and attached to a steering rocker bar via a steering hinge adapted so that the rear vertical yoke can rotate, relative to the steering rocker bar, about the steering hinge. First and second tie-rod plates attach the rear vertical yoke to first and second tie-rod support members, which are themselves attached to first and second tie-rods. The tie-rods are also linked to the wheel axles via axle attachments. The first and second tie-rods are adapted such that rotating the rear vertical yolk clockwise about the steering hinge pushes and pulls on the tie-rods and causes the first and second wheels to turn right and rotating the rear vertical yolk counterclockwise about the steering hinge pulls and pushes on the tie-rods and causes the first and second wheels to turn left.

### BRIEF DESCRIPTION OF THE DRAWINGS

The aforementioned and other features and objects of the present invention and the manner of attaining them will become more apparent and the invention itself will be best understood by reference to the following descriptions of a preferred embodiment and other embodiments taken in conjunction with the accompanying drawings, wherein:

FIG. 1 illustrates a top left side perspective view of an exemplary embodiment of a two wheel tilt steering wheelbarrow with wheels turned to the right;

FIG. 2A illustrates a front elevation view of an exemplary embodiment of a two wheel tilt steering wheelbarrow with wheels turned to the right;

FIG. 2B illustrates a front elevation view of an exemplary embodiment of a two wheel tilt steering wheelbarrow with wheels turned to the left;

FIG. 3A illustrates a side elevation view of an exemplary embodiment of a two wheel tilt steering wheelbarrow with wheels turned to the right;

FIG. 3B illustrates a side elevation view of an exemplary embodiment of a two wheel tilt steering wheelbarrow with wheels turned to the left;

FIG. 4A illustrates a rear elevation view of an exemplary embodiment of a two wheel tilt steering wheelbarrow with wheels turned to the right;

FIG. 4B illustrates a side elevation view of an exemplary embodiment of a two wheel tilt steering wheelbarrow with wheels turned to the left;

FIG. 5 illustrates a bottom plan view of an exemplary embodiment of a two wheel tilt steering wheelbarrow with wheels turned to the right;

FIG. 6 illustrates a rear elevation view of an exemplary embodiment of a two wheel tilt steering wheelbarrow with wheels turned to the left;

FIG. 7 illustrates a rear elevation view of an exemplary embodiment of a steering mechanism for a two wheel tilt steering wheelbarrow turned to the left;

FIG. 8 illustrates a side perspective view of an exemplary embodiment of a steering mechanism for a two wheel tilt steering wheelbarrow turned to the right.

### DETAILED DESCRIPTION

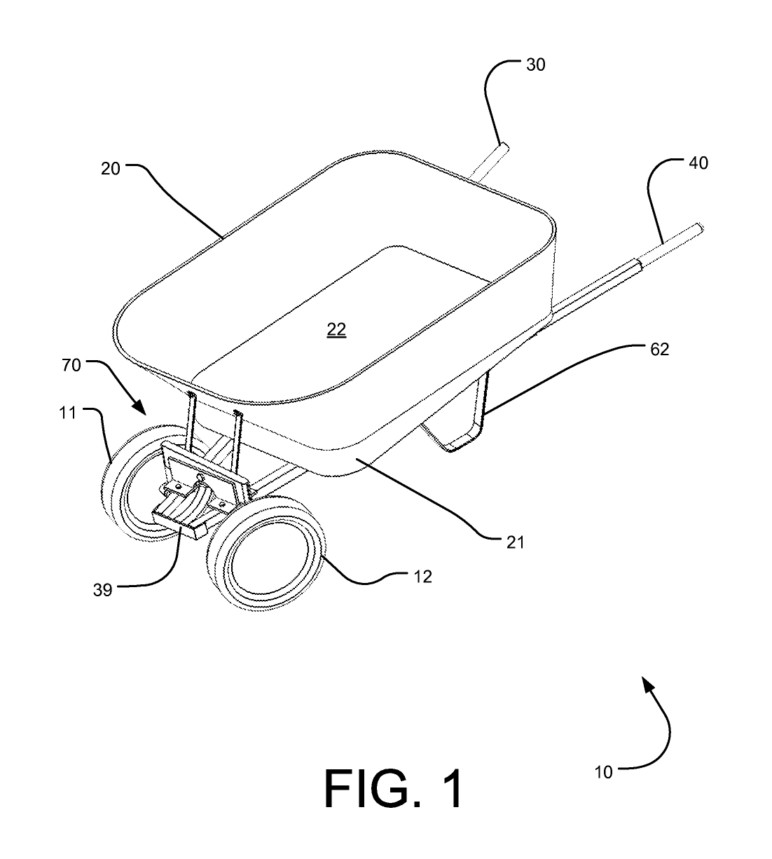

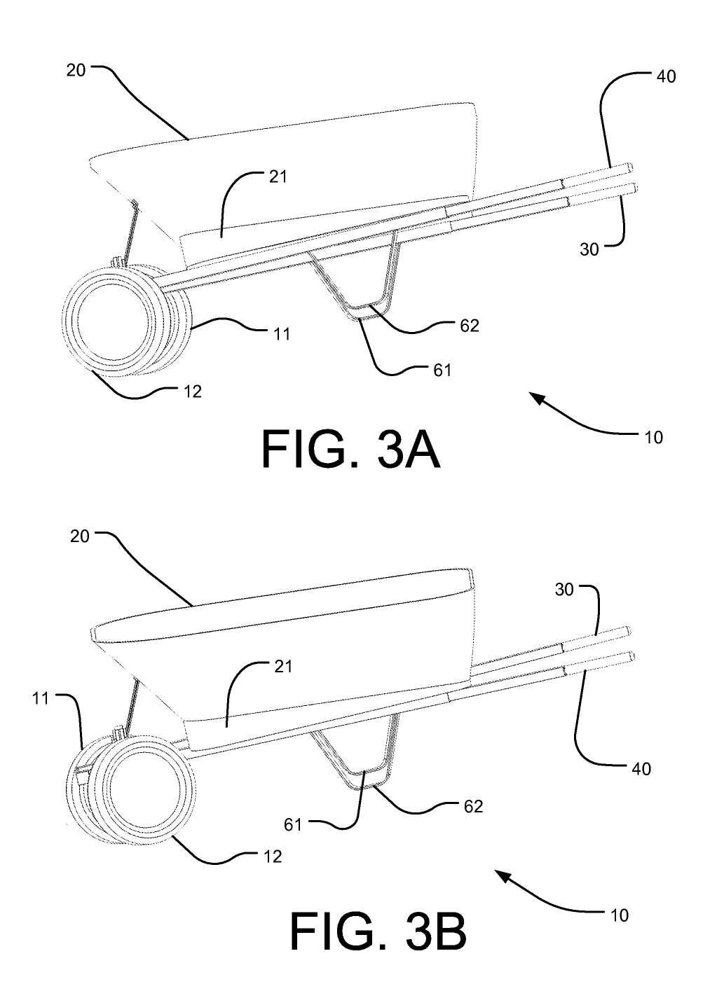

Referring now to the drawings, FIG. 1 illustrates a top left side perspective view of an exemplary embodiment of a two wheel tilt steering wheelbarrow 10 with wheels 11 and 12 turned to the right. In order to turn the wheels to the right, the operator must have lowered the first handle 30 and/or raised the second handle 40. This action causes the wheels to turn to the right. Raising the first handle 30 and/or lowering the second handle 40 causes the wheels to turn to the left. The steering mechanism is integrated into the front steering apparatus 70, see later FIGs. for more detail. Additional components that can comprise the two wheel tilt steering wheelbarrow include a tray 20 with tray bottom 22, a tray reinforcement 21, a handle crossbar 39, and first and second skid legs 61 and 62 (the first skid leg 61 is not visible in FIG. 1, see FIGS. 3A and 3B).

The tray reinforcement 21 can comprise a sheet of steel or similarly strong material that is placed between the tray bottom 22 and the handles 30 and 40 to spread out the load of the tray 20 and its contents over a wide bearing surface. This prevents the tray bottom 22 from deforming around the handles 30 and 40 when under heavy load. Additionally, the tray reinforcement 21 can further comprise angle offsets (either two angle offsets, one between each handle 30 and 40 and the tray bottom 22, or a single angle offset that spans both handles) as depicted by the angle shape of the tray reinforcement 21 in FIG. 1. The tray reinforcement 21 can comprise a tray attachment means and serves as a way to attach the tray 20 to the handles 30 and 40.

Although not illustrated in the FIGs., the invention may further include a braking system, lights, powered/motorized wheels, a dumping mechanism, and additional add-on features.

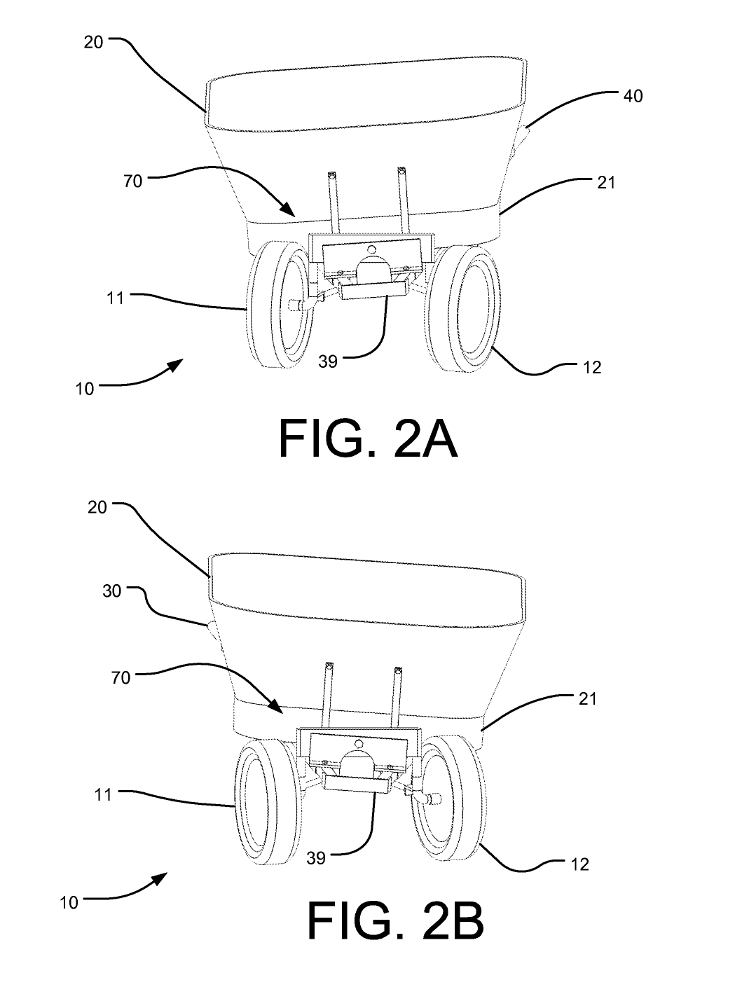

FIG. 2A illustrates a front elevation view of an exemplary embodiment of a two wheel tilt steering wheelbarrow 10 with wheels 11 and 12 turned to the right. The angle of the tray 20 is illustrated quite clearly and shows that for the wheels 11 and 12 to turn right, the operator must lower the right or first handle 30 and/or raise the left or second handle 40. This is a natural movement for the operator as a single wheel wheelbarrow will also turn right when the handles are manipulated as above; although, the turning mechanism that accomplishes this on a single wheel wheelbarrow is quite different, as the wheel itself does not turn relative to the remainder of the single wheel wheelbarrow.

FIG. 2B illustrates a front elevation view of an exemplary embodiment of a two wheel tilt steering wheelbarrow 10 with wheels 11 and 12 turned to the left. The angle of the tray 20 is illustrated quite clearly and shows that for the wheels 11 and 12 to turn left, the operator must raise the right or first handle 30 and/or lower the left or second handle 40. This is a natural movement for the operator as a single wheel wheelbarrow will also turn left when the handles are manipulated as above; although, the turning mechanism that accomplishes this on a single wheel wheelbarrow is quite different, as the wheel itself does not turn relative to the remainder of the single wheel wheelbarrow.

FIG. 3A illustrates a side elevation view of an exemplary embodiment of a two wheel tilt steering wheelbarrow 10 with wheels 11 and 12 turned to the right. This FIG. is showing the same turning process as in FIG. 2A but from a side viewing angle. Note how the left or second handle 40 is higher than the right or first handle 30. Similarly, the left or second skid leg 62 is higher than the right or first skid leg 61.

FIG. 3B illustrates a side elevation view of an exemplary embodiment of a two wheel tilt steering wheelbarrow 10 with wheels 11 and 12 turned to the left. This FIG. is showing the same turning process as in FIG. 2B but from a side viewing angle. Note how the left or second handle 40 is lower than the right or first handle 30. Similarly, the left or second skid leg 62 is lower than the right or first skid leg 61.

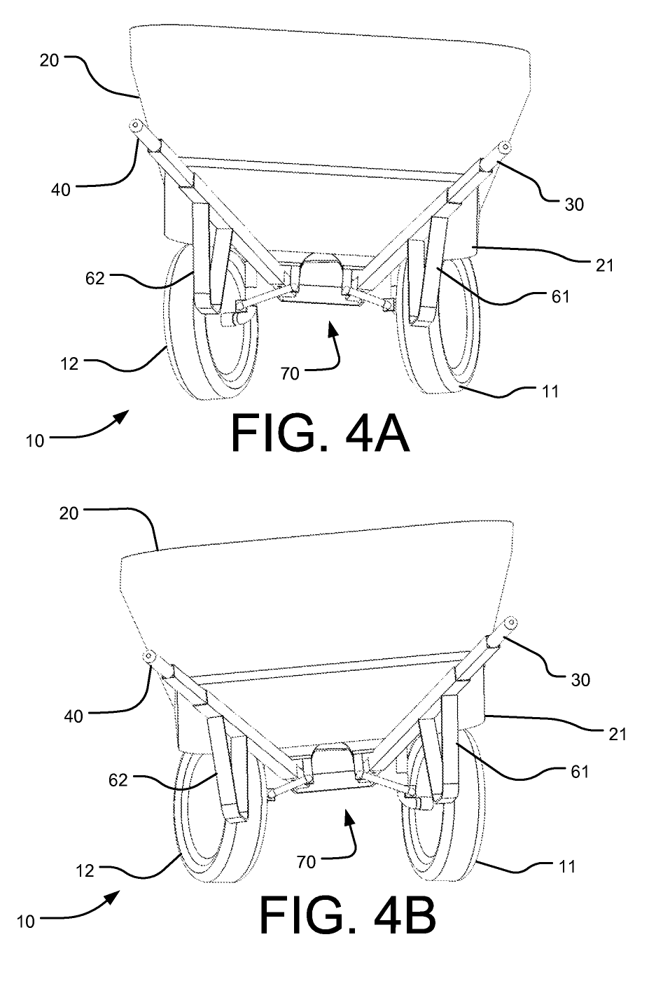

FIG. 4A illustrates a rear elevation view of an exemplary embodiment of a two wheel tilt steering wheelbarrow 10 with wheels 11 and 12 turned to the right. This FIG. is showing the same turning process as in FIGS. 2A and 3A but from a rear viewing angle. Note how the left or second handle 40 is higher than the right or first handle 30. Similarly, the left or second skid leg 62 is higher than the right or first skid leg 61. These relative positions cause the wheels 11 and 12 to turn to the right as illustrated in FIG. 4A.

FIG. 4B illustrates a side elevation view of an exemplary embodiment of a two wheel tilt steering wheelbarrow 10 with wheels 11 and 12 turned to the left. This FIG. is showing the same turning process as in FIGS. 2B and 3B but from a rear viewing angle. Note how the left or second handle 40 is lower than the right or first handle 30. Similarly, the left or second skid leg 62 is lower than the right or first skid leg 61. These relative positions cause the wheels 11 and 12 to turn to the left as illustrated in FIG. 4B.

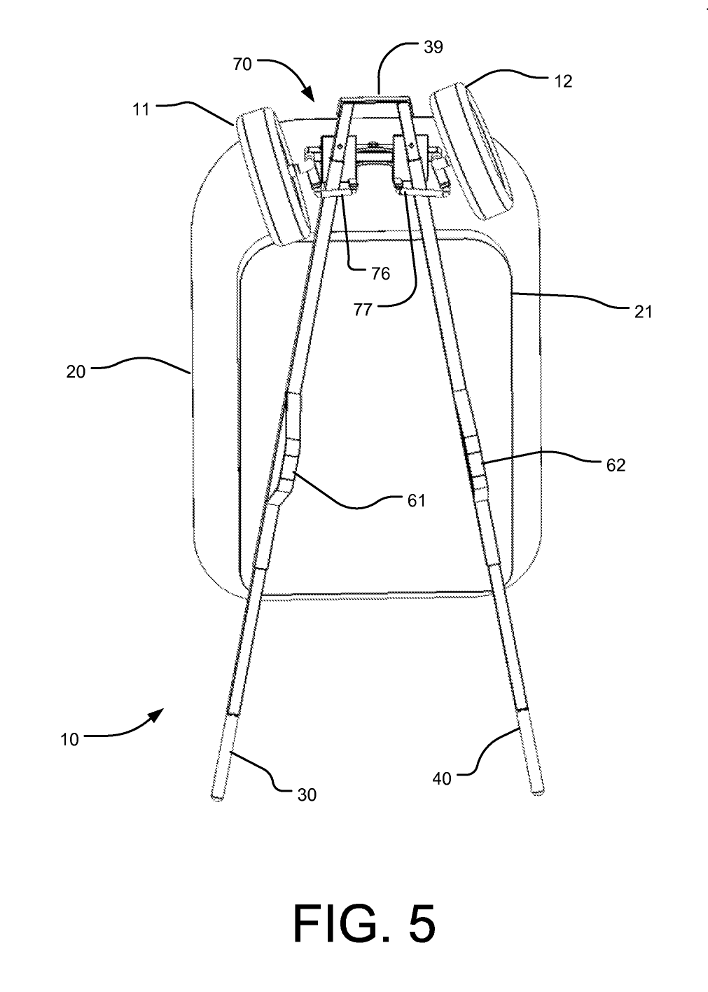

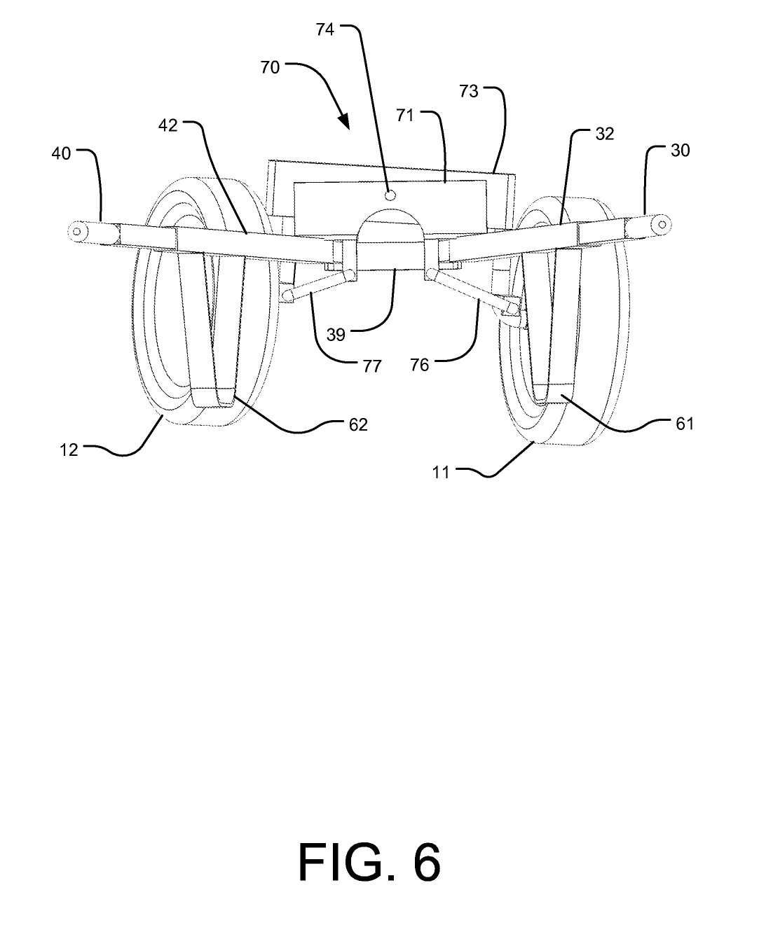

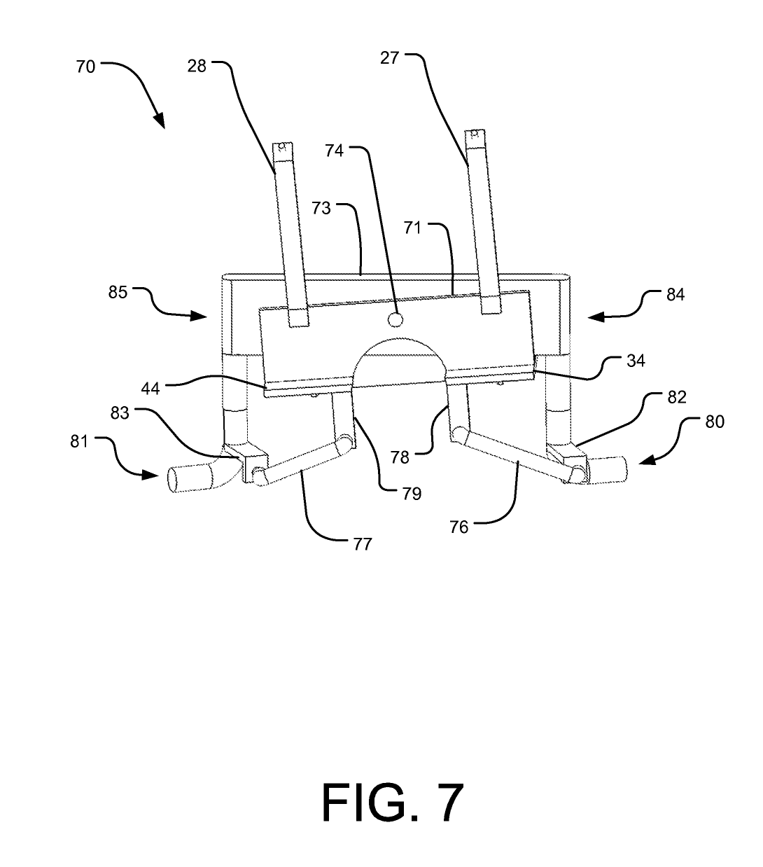

FIG. 5 illustrates a bottom plan view of an exemplary embodiment of a two wheel tilt steering wheelbarrow 10 with wheels 11 and 12 turned to the right. From this viewing angle, the right or first tie-rod 76 and the left or second tie-rod 77 are clearly visible. Each tie-rod 76 and 77 connects an axle (see FIG. 7, items 80 and 81) to a tie-rod support member (see FIG. 7, items 78 and 79). These tie-rod support members are fixed relative to the handles and so help to transfer handle motion through the tie-rods 76 and 77 to the axles and thereby cause the wheels 11 and 12 to turn. This process can be seen more clearly in FIGS. 6-8 below.

Note that in FIG. 5, if one where to extend the first handle 30 and the second handle 40 further forwards beyond the handle crossbar 39, the two handles would meet at an acute angle to one another.

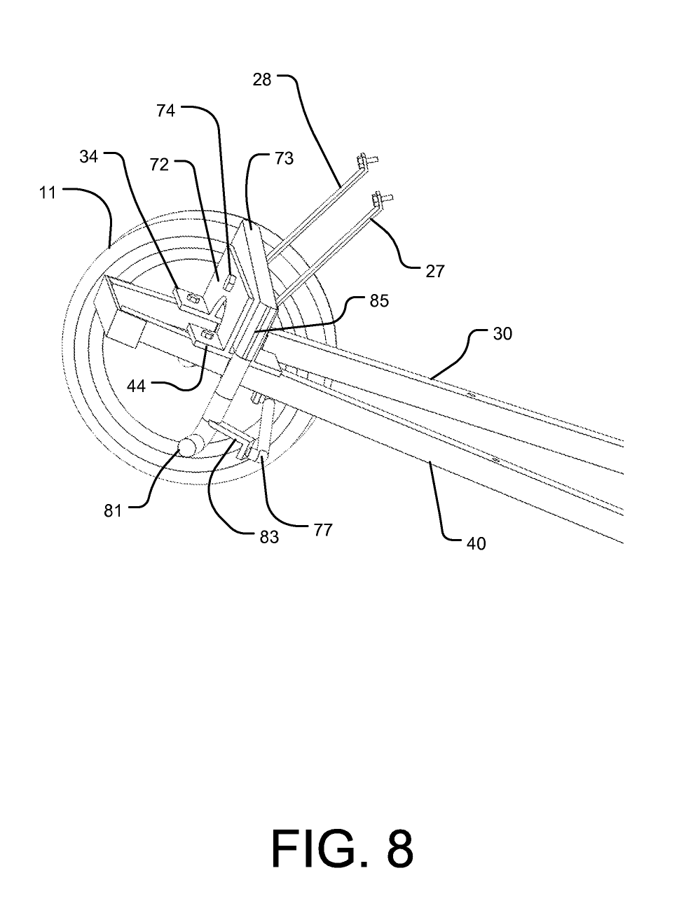

FIG. 6 illustrates a rear elevation view of an exemplary embodiment of a two wheel tilt steering wheelbarrow 10 with wheels 11 and 12 turned to the left. Additional components of the front steering apparatus 70 can be seen in this FIG., they include the rear vertical yoke 71, the steering rocker bar 73, and the steering hinge 74. The rear vertical yoke 71 functions together with the front vertical yoke (not shown in FIG. 6, see FIG. 8 component 72) to provide a reinforced channel within which the steering rocker bar 73 can rotate (relative to the yokes) on the steering hinge 74. In another embodiment, only a single vertical yoke is utilized. Note that if a bolt or similar apparatus is used as the steering hinge 74, simply by tightening the bolt, the ease of steering can be reduced. Similarly, by loosening the bolt, the ease of steering can be increased.

From the view perspective illustrated in FIG. 6, when the rocker bar 73 rotates clockwise, the right end of the bar 73 swings down and the left end swings up, relative to the vertical yoke 71. Conversely, when the rocker bar 73 rotates counter-clockwise, the right end of the bar 73 swings up and the left end swings down, again, relative to the vertical yoke 71. However, since the rocker bar 73 is attached to the axles 80 and 81 (see FIG. 7, the ends of the rocker arm 73 house the axle sleeves 84 and 85 which receive the upper portions of the axles 80 and 81), which are themselves attached to the wheels 11 and 12 and the wheels themselves do not travel vertically relative to each other (i.e., no independent front suspension), the rocker arm itself is not actually rotating. Instead, the vertical yoke 71 is performing a rotation about the steering hinge 74 when the handles are raised/lowered relative to each other. The vertical yoke 71 and 72 rotation acts on the tie-rods 76 and 77, pushing/pulling them and thereby causing the wheels 11 and 12 to turn.

Also illustrated in FIG. 6 are the handle reinforcement sleeves 32 and 42. The first handle reinforcement sleeve 32 receives within it the first handle 30 and provides a reinforced attachment to the first skid leg 61. In another embodiment, the first handle reinforcement sleeve 32 can also extend under the rear vertical yoke 71 and be affixed thereto (in yet another embodiment, the first handle reinforcement sleeve 32 can extend under the front vertical yoke 72 and be affixed thereto). The second handle reinforcement sleeve 42 receives within it the second handle 40 and provides a reinforced attachment to the second skid leg 62. In another embodiment, the second handle reinforcement sleeve 42 can also extend under the rear vertical yoke 71 and be affixed thereto (in yet another embodiment, the second handle reinforcement sleeve 42 can extend under the front vertical yoke 72 and be affixed thereto). Although FIG. 6 illustrates the sleeves 32 and 42 providing reinforced attachment to the skid legs 61 and 62, other embodiments in which the skid legs 61 and 62 attach directly to the handles 30 and 40 are contemplated.

Although the embodiment illustrated in FIG. 6 shows the handle sleeves 32 and 42 as being four sided rectangles, one, two, or three sided sleeves are contemplated (with the covered side(s) being any combination of top, bottom, left and right). Similarly, if round handles are used, the sleeves can be cylinders or portions thereof. In yet another embodiment, no handle sleeves are utilized.

FIG. 7 illustrates a rear elevation view of an exemplary embodiment of a steering mechanism for a two wheel tilt steering wheelbarrow 10 turned to the left. When the operator tilts the tray of the wheelbarrow by lowering the left or second handle 40 and raising the right or first handle 30, the rear (and front) vertical yokes 71 and 72 are forced to rotate about the steering hinge 74. This occurs because the tray is attached to the rear vertical yoke 71 via the first and second tray reinforcement members 27 and 28 and also because the tray is bolted to the handles (via the tray reinforcement 21), to which the vertical yokes 71 and 72 are also attached (via the tie-rod plates 34 and 44). Thus, by tilting the handles, the operator is tilting the tray and forcing the vertical yokes 71 and 72 to rotate on the steering hinge 74. This motion forces the tie-rod support members 78 and 79 to move. When the vertical yoke 71 rotates counter-clockwise (as in FIG. 7), the first tie-rod support member 78 is pulled upwards. Since the first tie-rod support member 78 is connected to the first tie-rod 76 (via a ball-and-socket or other type of joint), this upwards motion pushes on the first tie-rod 76 pushing it outwards and causing the tie-rod to push on the first axle attachment 82. This pushing motion forces the first axle 80 to rotate counterclockwise (when viewed from above), causing the attached wheel 11 to turn counterclockwise (or left) as well.

Similarly, when the vertical yoke 71 rotates counter-clockwise (as in FIG. 7), the second tie-rod support member 79 is pushed downwards. Since it is connected to the second tie-rod 77 (via a ball-and-socket or other type of joint), this downwards motion pulls on the second tie-rod 77 drawing it inwards and causing the tie-rod to pull on the second axle attachment 83. This pulling motion forces the second axle 81 to rotate counterclockwise (when viewed from above), causing the attached wheel 12 to turn counterclockwise (or left) as well.

The axles 80 and 81 are bent at approximately ninety degrees so that the horizontal portions can attach to the wheels 11 and 12, while the vertical portions attach to the axle sleeves 84 and 85 (which are themselves affixed to the steering rocker bar 73).

FIG. 8 illustrates a side perspective view of an exemplary embodiment of a steering mechanism for a two wheel tilt steering wheelbarrow 10 turned to the right. This view illustrates the second or front vertical yoke 72. The first tie-rod plate 34 and the second tie-rod plate 44 are illustrated. These plates 34 and 44 are affixed to the vertical yokes 71 and 72 and provide rigid attachment of the yokes to the handles 30 and 40. The first and second tie-rod support members 78 and 79 are also affixed to the plates 34 and 44, respectively.

Notice how the front vertical yoke 72 bridges the first and second handles by attaching to the first handle 30 via the first tie-rod plate 34 and attaching to the second handle 40 via the second tie-rod plate 44. The first and second tie-rod plates 34 and 44 can extend back towards the rear of the wheelbarrow such that the rear vertical yoke 71 (not labeled in FIG. 8, see earlier Figures) is attached to them as well and similarly bridges the first and second handles 30 and 40. In the embodiment shown in FIG. 8, both a front and rear vertical yoke 72 and 71 are illustrated. In other embodiments, only one or the other can be utilized. Of course, when both are present, the resulting steering mechanism can be made stronger with lighter materials versus if only one is used.

While particular embodiments have been described and disclosed in the present application, it is clear that any number of permutations, modifications, or embodiments may be made without departing from the spirit and the scope of this disclosure.

Particular terminology used when describing certain features or aspects of the embodiments should not be taken to imply that the terminology is being redefined herein to be restricted to any specific characteristics, features, or aspects with which that terminology is associated. In general, the terms used in the following claims should not be construed to be limited to the specific embodiments disclosed in the specification, unless the above Detailed Description section explicitly defines such terms. Accordingly, the actual scope of the claims encompasses not only the disclosed embodiments, but also all equivalent ways of practicing or implementing the claimed subject matter.

The above detailed description of the embodiments is not intended to be exhaustive or to limit the invention to the precise embodiment or form disclosed herein or to the particular field of usage mentioned in this disclosure. While specific embodiments of, and examples for, the invention are described above for illustrative purposes, various equivalent modifications are possible within the scope of the invention, as those skilled in the relevant art will recognize. Also, the teachings of the invention provided herein can be applied to other systems, not necessarily the system described above. The elements and acts of the various embodiments described above can be combined to provide further embodiments.

Any patents, applications and other references that may be listed in accompanying or subsequent filing papers are incorporated herein by reference. Aspects of the invention can be modified, if necessary, to employ the systems, functions, and concepts of the various references to provide yet further embodiments of the invention.

In light of the above “Detailed Description,” the Inventor may make changes to the invention. While the detailed description outlines possible embodiments of the invention and discloses the best mode contemplated, no matter how detailed the above appears in text, the invention may be practiced in a myriad of ways. Thus, implementation details may vary considerably while still being encompassed by the spirit of the invention as disclosed by the inventor. As discussed herein, specific terminology used when describing certain features or aspects of the invention should not be taken to imply that the terminology is being redefined herein to be restricted to any specific characteristics, features, or aspects of the invention with which that terminology is associated.

While certain aspects of the invention are presented below in certain claim forms, the inventor contemplates the various aspects of the invention in any number of claim forms. Accordingly, the inventor reserves the right to add additional claims after filing the application to pursue such additional claim forms for other aspects of the invention.

The above specification, examples and data provide a description of the structure and use of exemplary implementations of the described articles of manufacture and methods. It is important to note that many implementations can be made without departing from the spirit and scope of the invention.

What is claimed is:

1. A two wheel tilt steering wheelbarrow, comprising:
a first handle extending longitudinally from a proximal end to a distal end;
the first handle extending at an acute angle to a second handle, such that the distance between the first handle and the second handle is greater at the proximal end than at the distal end;
the first and second handles adapted at the proximal end to be each grasped by a hand of a user;
a tray attached via a tray reinforcement to the first and second handles;
the tray reinforcement adapted to reinforce the tray and provide a solid attachment between the tray and the first and second handles;
a first skid leg attached via a first skid leg attachment means to the first handle and located generally below the tray;
a second skid leg attached via a second ski leg attachment means to the second handle and located generally below the tray;
a first wheel and a second wheel, the first and second wheels connected to a front steering apparatus;
the front steering apparatus adapted so that raising the first handle relative to the second handle causes the first and second wheels to turn left and lowering the first handle relative to the second handle causes the first and second wheels to turn right; and
a first axle attached to the first wheel and to the front steering apparatus and a second axle attached to the second wheel and to the front steering apparatus.

2. The two wheel tilt steering wheelbarrow of claim 1, wherein the front steering apparatus further comprises:
a rear vertical yoke;
a steering rocker bar;
a steering hinge adapted so that the rear vertical yoke can rotate, relative to the steering rocker bar, about the steering hinge;
a first tie-rod plate and a second tie-rod plate, the first tie-rod plate attached to the rear vertical yoke and having protruding therefrom a first tie-rod support member;
the second tie-rod plate attached to the rear vertical yoke and having protruding therefrom a second tie-rod support member;
the first tie-rod plate also attached to the first handle;
the second tie-rod plate also attached to the second handle;
a first tie-rod attached at a first tie-rod first end to the first tie-rod support member and also attached at a first tie-rod second end to the first axle via a first axle attachment; and
a second tie-rod attached at a second tie-rod first end to the second tie-rod support member and also attached at a second tie-rod second end to the second axle via a second axle attachment, the first and second tie-rods adapted such that rotating the rear vertical yolk clockwise about the steering hinge pushes and pulls on the tie-rods and causes the first and second wheels to turn right and rotating the rear vertical yolk counterclockwise about the steering hinge pushes and pulls on the tie-rods and causes the first and second wheels to turn left.

3. The two wheel tilt steering wheelbarrow of claim 1, further comprising:
a first handle reinforcement sleeve attached to the first handle and a second handle reinforcement sleeve attached to the second handle.

4. The two wheel tilt steering wheelbarrow of claim 2, further comprising:
a first handle reinforcement sleeve attached to the first handle and a second handle reinforcement sleeve attached to the second handle.

5. The two wheel tilt steering wheelbarrow of claim 1, further comprising:
a first tray reinforcement member extending from the rear vertical yoke to the tray and a second tray reinforcement member extending from the rear vertical yoke to the tray.

6. The two wheel tilt steering wheelbarrow of claim 2, further comprising:
a first tray reinforcement member extending from the rear vertical yoke to the tray and a second tray reinforcement member extending from the rear vertical yoke to the tray.

7. The two wheel tilt steering wheelbarrow of claim 3, further comprising:
a first tray reinforcement member extending from the rear vertical yoke to the tray and a second tray reinforcement member extending from the rear vertical yoke to the tray.

8. The two wheel tilt steering wheelbarrow of claim 4, further comprising:
a first tray reinforcement member extending from the rear vertical yoke to the tray and a second tray reinforcement member extending from the rear vertical yoke to the tray.

9. The two wheel tilt steering wheelbarrow of claim 1 wherein the first and second handles are attached to each other via a handle crossbar at the distal end.

10. The two wheel tilt steering wheelbarrow of claim 8 wherein the first and second handles are attached to each other via a handle crossbar at the distal end.

11. A two wheel tilt steering wheelbarrow, comprising:
a first handle extending longitudinally from a proximal end to a distal end;
the first handle extending at an acute angle to a second handle, such that the distance between the first handle and the second handle is greater at the proximal end than at the distal end;
the first and second handles adapted at the proximal end to be each grasped by a hand of a user;
a tray attached via a tray reinforcement to the first and second handles;
the tray reinforcement adapted to reinforce the tray and provide a solid attachment between the tray and the first and second handles;
a first skid leg attached via a first skid leg attachment means to the first handle and located generally below the tray;
a second skid leg attached via a second ski leg attachment means to the second handle and located generally below the tray;
a first wheel and a second wheel, the first and second wheels connected to a front steering apparatus;
the front steering apparatus adapted so that raising the first handle relative to the second handle causes the first and second wheels to turn left and lowering the first handle relative to the second handle causes the first and second wheels to turn right;
a first axle attached to the first wheel and to the front steering apparatus and a second axle attached to the second wheel and to the front steering apparatus; and
wherein the front steering apparatus further comprises:
a rear vertical yoke bridging the first and second handles;
a steering rocker bar extending longitudinally from a first end to a second end, the steering rocker bar attached to the rear vertical yoke via a steering hinge;
the steering hinge adapted so that the rear vertical yoke can rotate, relative to the steering rocker bar, about the steering hinge;
the first axle extending from the first end of the steering rocker bar and the second axle extending from the second end of the steering rocker bar;
a first tie-rod plate and a second tie-rod plate, the first tie-rod plate attached to the rear vertical yoke and having protruding therefrom a first tie-rod support member;
the second tie-rod plate attached to the rear vertical yoke and having protruding therefrom a second tie-rod support member;
the first tie-rod plate also attached to the first handle;
the second tie-rod plate also attached to the second handle;
a first tie-rod pivotably attached at a first tie-rod first end to the first tie-rod support member and also pivotably attached at a first tie-rod second end to the first axle via a first axle attachment; and
a second tie-rod pivotably attached at a second tie-rod first end to the second tie-rod support member and also pivotably attached at a second tie-rod second end to the second axle via a second axle attachment, the first and second tie-rods adapted such that rotating the rear vertical yolk clockwise about the steering hinge pushes and pulls on the tie-rods and causes the first and second wheels to turn right and rotating the rear vertical yolk counterclockwise about the steering hinge pushes and pulls on the tie-rods and causes the first and second wheels to turn left.

12. The two wheel tilt steering wheelbarrow of claim 11, further comprising:
a first handle reinforcement sleeve attached to the first handle and a second handle reinforcement sleeve attached to the second handle.

13. The two wheel tilt steering wheelbarrow of claim 11, further comprising:
a first tray reinforcement member extending from the rear vertical yoke to the tray and a second tray reinforcement member extending from the rear vertical yoke to the tray.

14. The two wheel tilt steering wheelbarrow of claim 12, further comprising:
a first tray reinforcement member extending from the rear vertical yoke to the tray and a second tray reinforcement member extending from the rear vertical yoke to the tray.

15. The two wheel tilt steering wheelbarrow of claim 11 wherein the first and second handles are attached to each other via a handle crossbar at the distal end.

16. The two wheel tilt steering wheelbarrow of claim 12 wherein the first and second handles are attached to each other via a handle crossbar at the distal end.

17. The two wheel tilt steering wheelbarrow of claim 13 wherein the first and second handles are attached to each other via a handle crossbar at the distal end.

18. The two wheel tilt steering wheelbarrow of claim 14 wherein the first and second handles are attached to each other via a handle crossbar at the distal end.

19. A two wheel tilt steering wheelbarrow, comprising:
a first handle extending longitudinally from a proximal end to a distal end;
the first handle extending at an acute angle to a second handle, such that the distance between the first handle and the second handle is greater at the proximal end than at the distal end;
the first and second handles adapted at the proximal end to be each grasped by a hand of a user;
a tray attached via a tray reinforcement to the first and second handles;
the tray reinforcement adapted to reinforce the tray and provide a solid attachment between the tray and the first and second handles;
a first skid leg attached via a first skid leg attachment means to the first handle and located generally below the tray;
a second skid leg attached via a second ski leg attachment means to the second handle and located generally below the tray;
a first wheel and a second wheel, the first and second wheels connected to a front steering apparatus;
the front steering apparatus adapted so that raising the first handle relative to the second handle causes the first and second wheels to turn left and lowering the first handle relative to the second handle causes the first and second wheels to turn right;
a first axle attached to the first wheel and to the front steering apparatus and a second axle attached to the second wheel and to the front steering apparatus; and
wherein the front steering apparatus further comprises:
a rear vertical yoke bridging the first and second handles;
a front vertical yoke extending parallel to the rear vertical yoke and also bridging the first and second handles;
a steering rocker bar extending longitudinally from a first end to a second end, the steering rocker bar attached to and between the front vertical yoke and the rear vertical yoke via a steering hinge;
the steering hinge adapted so that the steering rocker bar can rotate relative to the front and rear vertical yokes, about the steering hinge;
the first axle extending from the first end of the steering rocker bar and the second axle extending from the second end of the steering rocker bar;
a first tie-rod plate and a second tie-rod plate, the first tie-rod plate attached to the rear vertical yoke and having protruding therefrom a first tie-rod support member;
the second tie-rod plate attached to the rear vertical yoke and having protruding therefrom a second tie-rod support member;
the first tie-rod plate also attached to the first handle;
the second tie-rod plate also attached to the second handle;
a first tie-rod pivotably attached at a first tie-rod first end to the first tie-rod support member and also pivotably attached at a first tie-rod second end to the first axle via a first axle attachment; and
a second tie-rod pivotably attached at a second tie-rod first end to the second tie-rod support member and also pivotably attached at a second tie-rod second end to the second axle via a second axle attachment, the first and second tie-rods adapted such that rotating the rear vertical yolk clockwise about the steering hinge pushes and pulls on the tie-rods and causes the first and second wheels to turn right and rotating the rear vertical yolk counterclockwise about the steering hinge pushes and pulls on the tie-rods and causes the first and second wheels to turn left.

20. The two wheel tilt steering wheelbarrow of claim 19, further comprising:
a first tray reinforcement member extending from the rear vertical yoke to the tray and a second tray reinforcement member extending from the rear vertical yoke to the tray.
